(19) United States
(12) Patent Application Publication
(10) Pub. No.: US 2017/0103221 A1
(43) Pub. Date: Apr. 13, 2017

(54) ACCESS CONTROL MANAGEMENT OF DEBUGGING PROCESSES

(71) Applicant: International Business Machines Corporation, Armonk, NY (US)

(72) Inventors: Prateek Goel, Bangalore (IN); Shailaja Mallya, Mangalore (IN)

(21) Appl. No.: 14/876,964

(22) Filed: Oct. 7, 2015

(51) Int. Cl. G06F 21/62; G06F 11/273

(52) U.S. Cl. CPC G06F 21/6218; G06F 11/273

(57) ABSTRACT

The computer-implemented method for managing a debugging process can include receiving a request for the debugging process from a first principal, the debugging process accesses a system process for an object of a computer program operating on a computer, the computer having a call stack that stores information about one or more active subroutines of the object. The method can also include determining that the first principal has at least an access permission to the object. The method can include granting, based on the access permission of the first principal, a debugging access permission to the first principal for a restricted code path of the call stack, the restricted code path allows a restricted view of the call stack to the first principal. The method can include providing one or more debugging details on the object to the first principal.

### BACKGROUND

The present disclosure relates to information security, and more specifically, to authorization and authentication of debugging processes.

If a first user wants to track a second user that is altering the resources owned by the first user, then the first user would most likely be given all permission to track/trace all events on the system. Receiving all permission can violate the ‘need to know’ principle which advocates that a user is privy to only what that user needs to know. This principle prevents any misuse of the information the first user is not privy to.

At the same time, when the first user has a privilege to perform an action on a resource, the first user should be able to do any tracing/debugging/accounting of file actions on that resource equivalent to the privilege. Tracing/debugging/accounting mechanisms may work on the concept of an initiator permissions matching with the process context in which trace/debug point is fired.

### SUMMARY

According to embodiments of the present disclosure, a method, system, and computer program product for managing a debugging process is presented.

The computer-implemented method for managing a debugging process can include receiving a request for the debugging process from a first principal, the debugging process accesses a system process for an object of a computer program operating on a computer, the computer having a call stack that stores information about one or more active subroutines of the object. The method can also include determining that the first principal has at least an access permission to the object. The method can include granting, based on the access permission of the first principal, a debugging access permission to the first principal for a restricted code path of the call stack, the restricted code path allows a restricted view of the call stack to the first principal. The method can include providing one or more debugging details on the object to the first principal.

The system for managing a debugging process can include a processor, and a memory communicatively coupled to the processor. The memory manages a call stack that stores information about one or more active subroutines of the object. The system can include an operating system communicatively coupled to the processor and the memory. The operating system is configured to create a system process for an object of a computer program and causes the processor to process one or more active subroutines of the object. The system can also include an operating system daemon, communicatively coupled to the processor and the memory, configured to receive a request for the debugging process from a first principal, the debugging process accesses a system process for the object of the computer program. The operating system daemon is configured to determine that the first principal has at least an access permission to the object. The operating system daemon is configured to grant, based on the access permission of the first principal, a debugging access permission to the first principal for a restricted code path of the call stack, the restricted code path allows a restricted view of the call stack to the first principal. The operating system daemon is configured to provide one or more debugging details on the object to the first principal.

The computer program product for managing a debugging process can include a computer readable storage device having a computer readable program stored therein. The computer readable program, when executed on a computing device, causes the computing device to receive a request for the debugging process from a first principal. The debugging process accesses a system process for an object of a computer program operating on a computer. The computer having a call stack that stores information about one or more active subroutines of the object. The computer readable program causes the computing device to determine that the first principal has at least an access permission to the object. The computer readable program causes the computing device to grant, based on the access permission of the first principal, a debugging access permission to the first principal for a restricted code path of the call stack, the restricted code path allows a restricted view of the call stack to the first principal. The computer readable program causes the computing device to provide one or more debugging details on the object to the first principal.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a block diagram of an operating system, according to various embodiments.

FIG. 2 illustrates a block diagram of an access control system that manages tracing of various system processes, according to various embodiments.

FIG. 3 illustrates a block diagram of an exemplary system that manages a debugging request, according to various embodiments.

FIG. 4 illustrates a flowchart of a method of providing access to a less than complete code path of a file process, according to various embodiments.

FIG. 5 illustrates a flowchart of a method of enabling a debugging process for a principal, according to various embodiments.

FIG. 6 illustrates a block diagram of a system that controls the tracing process of principals, according to various embodiments.

FIG. 7 illustrates a block diagram of automated computing machinery, according to an embodiment.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to information security, more particular aspects relate to authorization of debugging processes. For instance, aspects of the present disclosure can relate to providing a less than complete debugging access permission to an object based on an initiator status of a principal and a resource permission of the object. While the present disclosure is not necessarily limited to such applications, various aspects of the disclosure may be appreciated through a discussion of various examples using this context.

In a computing system, one or more principals may be performing various system processes to an object. The processes can include read or write processes to the object. A principal is an entity to which execution can be attributed. For example, principals can include users, processes, threads, or procedure activations. Objects can be entities on which operations are defined. Example of objects can include storage abstractions (e.g., memory, or files) and code abstractions (e.g., modules or services). The present disclosure may utilize users as an example of a principal and files as an example of an object.

A debugging process is generically a process used to debug another process. The debugging process may originate from a debugging program responsible for managing various debugging processes. A debugging process may include various tracing, accounting and other debugging processes that rely on the system processes to the object. The present disclosure relates to not considering a principal's context in which a debug/trace/accounting point is triggered, but the initiator's permissions and target resource permissions on which the action is being performed irrespective of the context.

For instance, the operating system daemon would be provided the access permissions of the object and, based on the access permissions of the object, the debugging processes can be performed on the system processes. Although tracing is used as an illustrative example, tracing debugging, accounting, and auditing may all be used and referred to as a Tracing, Accounting, Debugging (TAD) process. The TAD process may also be referred to generically as a debugging process. The operating system daemon is a computer program that runs as a background process of the operating system rather than being under the direct control of an interactive user. The operating system daemon forwards various service requests to other programs or processes as appropriate.

This implementation may have a number of advantages. For example, a reduction of misuse of objects. Users may track any resources they own. A user may also avoid exclusive reliance on an administrator. In a cloud-based scenario, where admins and users are in different time zones, users may have more freedom to do some basic level debugging and turn-around time issues could be reduced.

As an illustrative example, the following example of a password file may be used. For example, if a first user is reading and writing to a file via some application and a second user has access (read, write or both) to this file and wants to know who is altering the contents of this file, then the second user should be allowed to know how the file is altered by first user's process, but not know which other functions that were called by the first user's process and what were the things done by these other functions. For example, the first user might be changing a password which means the first user's process is altering the contents of the /etc/security/password file. The contents of the password file are encrypted, so the password changing process can take the first user's new password, encrypt it and store it in the /etc/security/password file.

During a debugging process, the second user can have access to the password file to trace the first user's process. If the second user were allowed to trace the first user's process and get the complete call stack, then the second user would be able to see the first user's clear text password sent to the encrypting functions. To avoid having access to the first user's password file, an additional check can be added to determine whether a process is started by the second user. If not, then the second user can be given a restricted view of the system process (e.g., the second user can see what is being written to the password file). The second user would see an encrypted version of the password file.

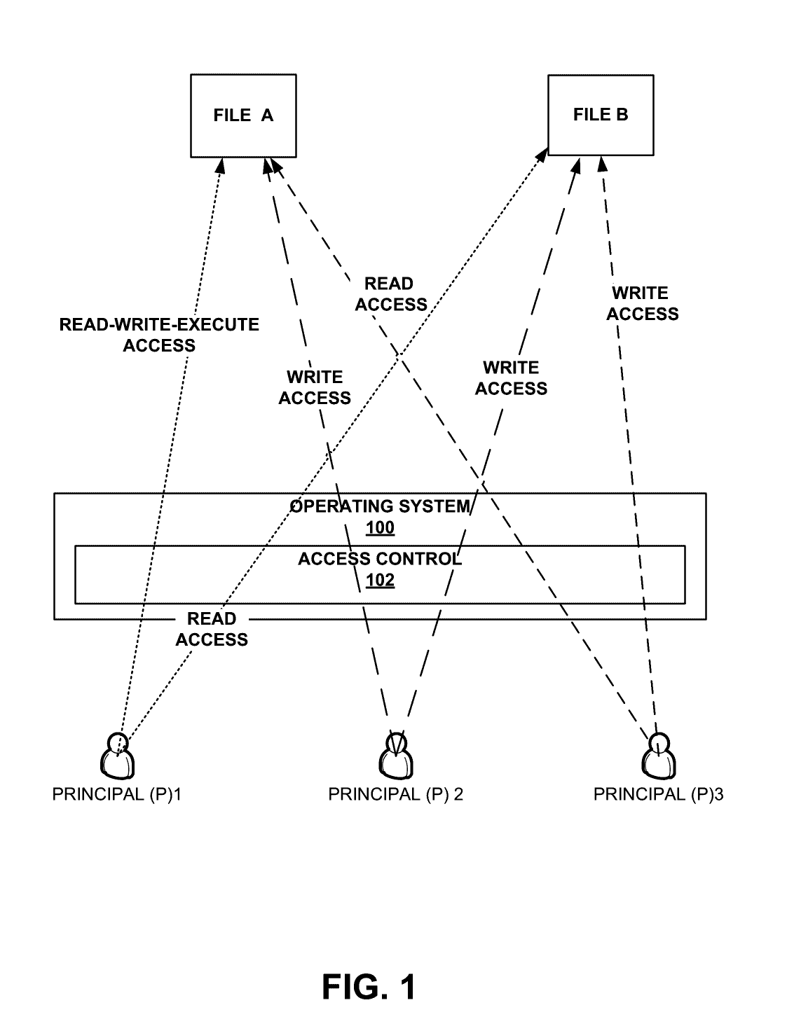

FIG. 1 illustrates a block diagram of an operating system 100, according to various embodiments. The operating system 100 may have an access control system 102 that performs access control on one or more system processes. The operating system 100 may utilize a daemon that facilitates the access control system 102. One or more principals (shown are principal 1 (hereinafter P1), principal 2 (hereinafter P2), and principal 3 (hereinafter P3)), may have various permissions to access the various objects (shown as File A and File B).

The access control system 102 can utilize discretionary access control (DAC) which restricts access to objects based on the identity of subjects and/or groups to which they belong. For example, P1 may belong to a group named “group1.” The DAC permissions can divided into 3 sets. (- - -) (- - -) (- - -). The first set belongs to the owner of the file. The second belongs to the group that has access to the file (usually a group that the owner is a member of). The third is for users who are neither the owners nor members of the group.

Each of the 3 dashes represent “read” “write” “execute” permissions in that order. (rwx)(rwx)(rwx).

Principal 1 may have read-write-execute access to file A.

(rwx)(-wx)(r--) 1 principal1 group1 2672392 Jul 15 10:17 fileA

The “rwx” in the LHS output shows that the principall has Read (r), Write (w), and execute (x) permission on the fileA.

(- -x) (- -x) (--x) 1 root system 2672392 Jul 15 10:17 TAD

The “x” in the RHS (Right hand side) set output shows that any user and hence the principall has execute (X) permission on the Trace/Accounting/Debuging (TAD) binary which means that P1 can run this command.

Principal 2 may have write access to file A based on the membership in group1.

(rwx) (-wx) (r--) 1 principall group1 2672392 Jul 15 10:17 fileA

(--x) (--x) (--x) 1 root system 2672392 Jul 15 10:17 TAD

The “x” in the RHS (Right hand side) set output shows that any user and hence the principal2 has execute (X) permission on the Trace/Accounting/Debuging (TAD) binary which means that P2 can also run this command.

Principal 3 may have read access to file A based on general access.

(rwx) (-wx) (r--) 1 principall group1 2672392 Jul 15 10:17 fileA

(--x) (--x) (--x) 1 root system 2672392 Jul 15 10:17 TAD

The “x” in the RHS (Right hand side) set output shows that any user and hence the principal3 has execute (X) permission on the Trace/Accounting/Debuging (TAD) binary which means that P3 can also run this command.

Thus, principals may have execute, read, write any combination of the DAC permissions on the fileA. In order to trace, a principal may have at least read access permission.

And in order to trace, the principal must have “x” execute permission to the TAD binary.

Without possessing an execute permission, principall will not be able to start a TAD process. With just the DAC “x” permission for any of the above cases, the TAD processes are designed such that P1 will be able to TAD only P1's process. For example, the following pseudocode illustrates this principle:

```
  syscall_read( )
  {
    if this process can be debugged/traced/accounted (If the process being
traced was started by the same principal who is invoking the TAD process)
    {
      do the task;
    }
  }
```

Aspects of the disclosure would allow P3 to be able to trace a process started by P1 as shown in the following pseudocode:

```
  syscall_read( )
  {
    if d/t/a framework activated
      branch to required framework debug/trace/accounting;
  }
  d/t/a framework( )
  {
    if ( target resource is being read is accessible/viewable by initiator
of t/d/a tool ) // in this case fd or say file can be read or written
    {
      do the task;
    }
  }
```

Same checks can be performed for system activity (e.g., for signals being sent). For example, if the signal is being sent to a process that belongs to the user who initiated the tracing/debugging/accounting tool, then the signal send activity is also tracked.

Aspects of the present disclosure concern how to fetch and manage access permissions to a TAD session/debugging process on an object. The fetched access permissions can be compared with the principal who has initiated the TAD session. Based on whether the principal initiated the TAD session or system process, the TAD action can be performed.

The access control 102 can also utilize role-based access control (RBAC). The present disclosure corrects a shortcoming in the RBAC model without modification of the RBAC model itself.

Consider a non-root/non-privileged user (e.g., principal 3) who has access to a particular file “File A” (an object). If P3 wanted to know who is writing/corrupting a resource that he has access to, then P3 is allowed to trace a system process that is modifying File A, which need not be a process started/executed by P3. In the current RBAC model, if a non-root user P3 wants to trace a process not started by P3, then P3 needs to be given a role which will enable P3 to the TAD processes on a system but doing so also gives P3 access to all the logs/traces for all the system processes on the system. If P3 is not given any privileges to trace other users' processes, then P3 is able to perform TAD processes on its own process and relies on the system admin/root to provide the required information about other processes modifying this file.

Aspects of the present disclosure enable this non-root user P3 to perform TAD processes on the system process that is not started by P3. The system process that P3 user is allowed to trace is the system process that is acting on an object to which P3 has at least view/read permission.

Referring to FIG. 1, P1 has owner read-write-execute access to File A and read access to File B. Thus, P1 has the authority to trace P3's or P2's system processes that are accessing File A. P2 has group write access can also trace P1's or P3's system processes that accesses File A. For example, if P2's group write access is causing corruption in File A, then P1 can trace P2's system processes. P3 has group read access to File A so that P3 can trace any processes by P1 or P2 that accesses the contents of File A.

Access permission can be granted by the access control system 102, the access permission can be granted by any form of access control (e.g., Discretionary Access Control (DAC), Role-Based Access Control (RBAC), Mandatory Access Control (MAC), etc.). In various embodiments, the existing access control system 102 is not modified. In the disclosure, references to DAC may be used but the access control system 102 can use RBAC privileges instead of DAC permissions as an implementation choice.

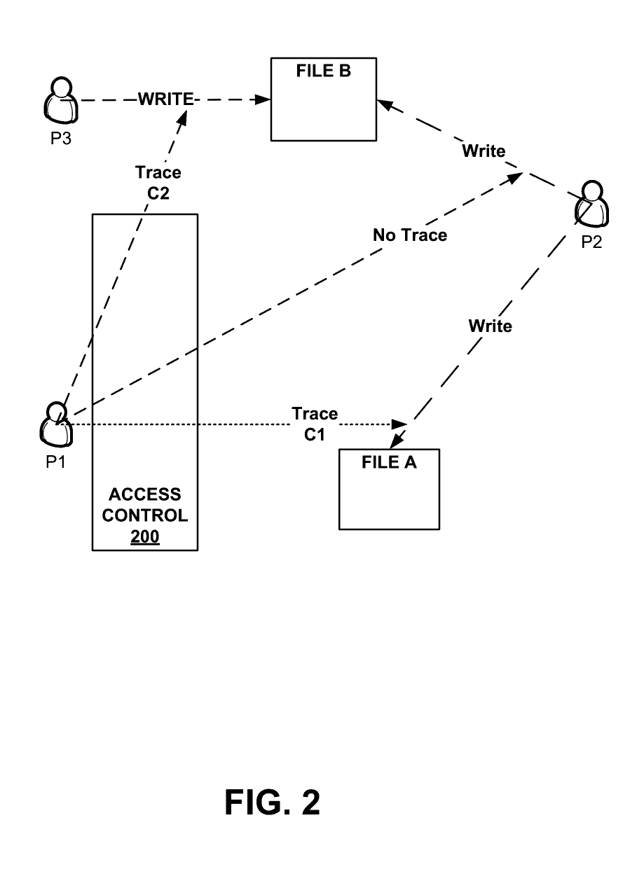

FIG. 2 illustrates a block diagram of an access control system 200 that manages tracing of various system processes, according to various embodiments. Interactions in FIG. 2 may be based on those from FIG. 1. For example, P2 may write to both File B and File A. P1 may own File A but not File B. P3 may have read access to File A and write access to File B. The access control system 200 may be comparable to access control system 102 from FIG. 1.

The approaches that are explained with tracing can be applied to debugging and auditing as well. FIG. 2 shows when P1 may trace a system process from P2. If P2 is writing to both File A and File B, then P1 may have access to trace the write system process from P2 to File A but not from P2 to File B because of lack of access permission to File B.

An aspect of the present disclosure is that that P1 is not allowed to gain access to the entire call stack of a system process started by P2. A “Need-to-know” principle is adhered to and write system actions to File A from P2 is visible to P1. For example, the tracing (debugging/auditing) utility may have 2 pre-compiled code paths, C1 and C2, as discussed further herein. Cl can include the full process tracing facility and C2 can include a restricted tracing facility.

When P1 tries to trace system process that was not started by P1 (e.g., from P3 to File B), code path C2 is traversed by the tracing utility to restrict P1's access to the entire call path of the system process being traced (assuming that permission is given to P1 by P3). However, if P1 started a write system process on File A, then the Cl code path is traversed by the tracing utility to give P1 full access to the entire call path of the write system process that P1 started. In both cases, the system process being traced is a process that is working on a resource to which P1 has at least read or write access. If P1 is given privileged access to trace processes, then P1's actions and access to the call stack of the system process may not change with respect to the access control.

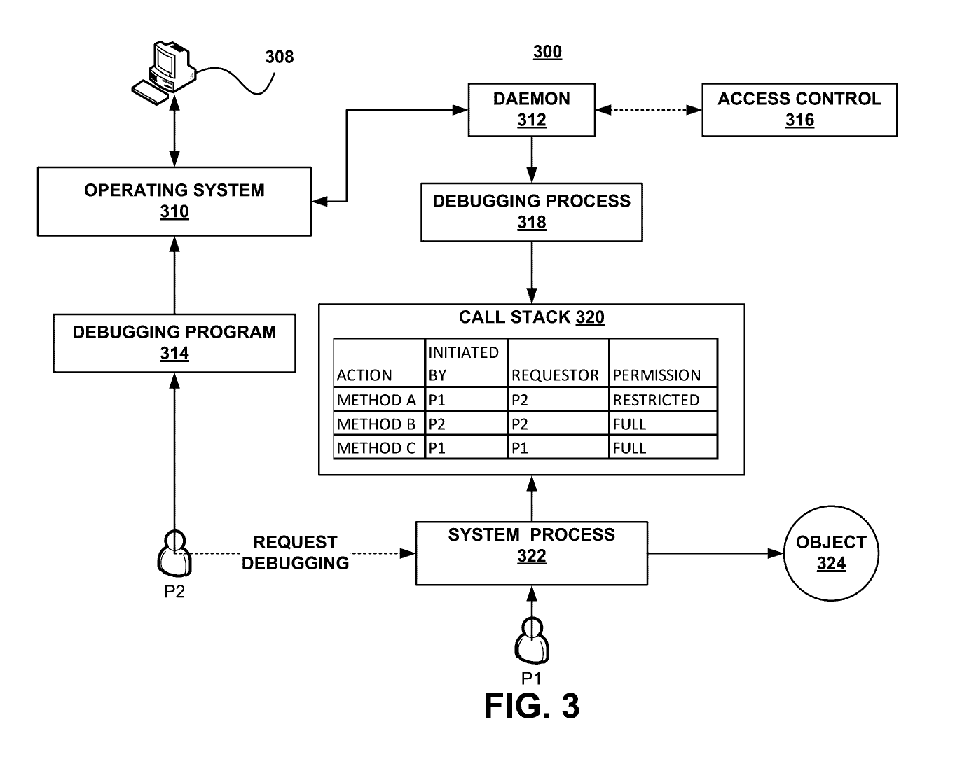

FIG. 3 illustrates a block diagram of an exemplary system 300 that manages a debugging request, according to various embodiments. The system 300 may include a computing device 308. The computing device 308 may have an operating system 310 that runs various computing instructions. The operating system 310 may have a daemon 312 that performs background tasks such as debugging. A tracing process/daemon can be still running in the background. A debugging process might end with the end of the system process being debugged. Various flowcharts and pseudocode may be illustrated exemplifying dynamic tracing or auditing rather than debugging.

At least two principals, P1 and P2, may interact with the computing device 308. As illustrated, P1 may initiate a system process 322. The system process 322 can be a read/write/execute instruction for an object 324. In various embodiments, the object 324 can be a file, a program, or a particular memory subdivision. The system process 322 can involve writing to the call stack 320. For example, the call stack 320 may record that P1 initiated method A.

P2 may request debugging of the system process 322 that was initiated by P1. P2 may request through a debugging program 314 which communicates with the operating system 310. The debugging program 314 initiates a debugging process similar to the following pseudocode:

Debugging process <Resource/object> <Action to trace Read/Write>

The last field means that, the first principal having read access or owning an object, can perform a trace/Audit/Debug on other processes that “Read”s or “write”s or does “both” on the object. For example, if the first principal is interested in only what is being written to an object and by whom but not who is reading it, then the first principal may perform a TAD processon the “write”s to the object. The debugging process can be executed as: “Debugging process <file1> <write>” which may trace the writes to file1.

In various embodiments, the daemon 312 may communicate with the access control system 316. The access control system 316 may be responsible for monitoring various access permissions of the object 324 and ensuring that the system process 322 is being accessed by a principal with the correct permissions. The daemon 312 can grant access to the call stack 320 for a debugging process 318. For example, the call stack 320 may have records of who the system process 322 was initiated by and who is requesting the debugging process 318. The daemon 312 can grant access to the debugging process 318 based on the initiator status. For example, the daemon 312 can grant full access to a code path from method B to P2. The daemon 312 can grant access to a restricted code path to P1 for method A.

A debugging process may have a full code path used when a first principal is trying to trace/audit/debug his own system process writing into the file. A restricted code path may be used when the first principal is trying to trace/audit/debug a process belonging to/started by a second principal, which is writing to a file.

The restricted code path allows a restricted view of the call stack. The second principal is not allowed to know the entire call stack that leads to the write/modify system action by the first principal's process. The second principal knows about the writes/modify to the file he has read/write access to.

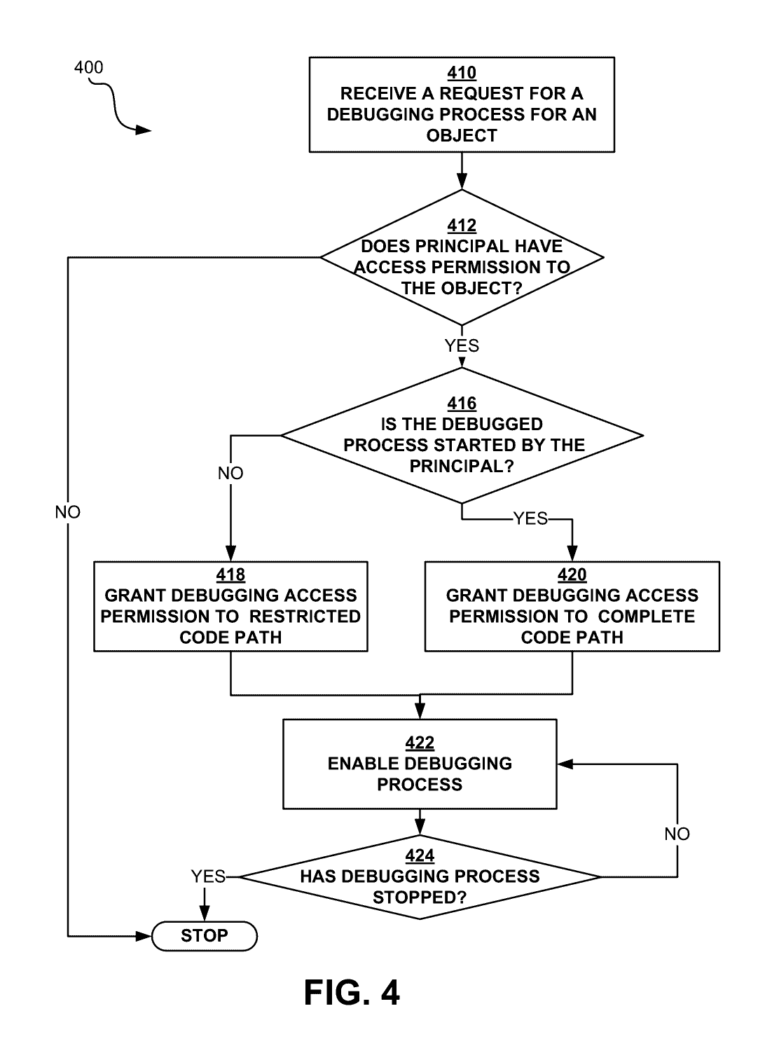

FIG. 4 illustrates a flowchart of a method 400 of providing access to a less than complete code path of a file process, according to various embodiments. Aspects of the method 400 can be implemented by an operating system daemon. Other aspects of method 400 may be implemented by an access control system. The method 400 may include receiving a debugging request for a system process relating to an object and determining if the debugged process is started by the principal. A principle of the method 400 is to guarantee that a user tracing actions on an object is not given access to more knowledge than required. Thus, a debugging process may have two code paths. A complete code path is selected when a debugging process is used by the first principal on a system process initiated by the first principal. A restricted code path is select when the first principal is using a debugging process on a system process not started by the first principal.

In operation 410, the debugging program may receive a request for a debugging process from a first principal. In various embodiments, a user may initiate a request for a debugging process through the debugging program. For example, a principal can specify “<debugging program/tool/utility> <Resource> <System process to trace Read/Write>” within the command line. When a request for debugging program is placed at the command line, the operating system can create the debugging process for the debugging program. Access control, (e.g., DAC) can be checked during exec (call) of an executable or when an object is being accessed (non-executable like a text file).

The request for a debugging process may be received by a daemon. The debugging process accesses a system process for an object of a computer program operating on a computer. The system process is a process that involves an action that the computer does with regard to the object. For example, the system process can include a read, write, or execute. The computer can have a call stack that stores information about one or more active subroutines of the object. For example, the call stack can also include the various system processes on the computer.

The first principal can be any entity (such as a user) that initiates the debugging process. The first principal can be the creator of the underlying system process and have a variety of privileges. In various embodiments, first principal is a non-root, non-privileged user. Thus, the first principal may only have read-only access to the system process. If the first principal has privileges, the privileges may enable the first principal to modify the system process and access various call stack entries with regard to the system process.

In operation 412, the daemon can check with the access control system to determine that the first principal has at least an access permission to the object. The access permission can include a read, write, or execute. A more restrictive access permission includes a read-only access permission. The access control system may use RBAC, DAC or any other method of access control. The daemon can check with the existing access control system to make the determination of access permissions. In order for the method 400 to proceed, the first principal may have at least a read access permission to the object. Otherwise, the daemon may exclude the first principal from running a debugging process for the system process.

In operation 416, the daemon can determine whether the debugged process is started by the first principal. The debugged process is the system process that is the subject of the debugging process request in operation 410. The daemon can determine whether the system process is initiated or started by the first principal. The daemon may perform this in a variety of ways. For example, the daemon can monitor the call stack to determine if the system process was initiated by the first principal. The daemon can also communicate with the access control system to determine the initiator of the system process. If the system process is started by a second principal, then the method 400 can continue to operation 418.

Operation 416 and operation 412 may occur in any order. For example, operation 416 may be implemented before operation 412 within method 400. In various embodiments, operation 416 may occur optionally. Thus, a principal may receive debugging access permission to a restricted code path based on the access permission of the principal to the object.

In operation 418, the daemon can grant debugging access permission to a restricted code path of the call stack. The debugging access permission can be based on the access permission of the first principal or a combination of the access permission of the first principal and whether the debugged system process was initiated by the first principal.

The restricted code path a debugging access permission to the first principal for a restricted code path of the call stack, the restricted code path allows a restricted view of the call stack to the first principal. In embodiments, the restricted view of the call stack is less than an administrator view of the call stack. For example, an administrator or root level user may have access to the entire call stack. The restricted view of the call stack may be anything less than the entire/complete view of the call stack.

The daemon can determine whether the first principal has a write access permission. The restricted view can be based on the permissions of the first principal. The granting of the debugging access permission for a restricted code path of the call stack can occur based on the write access permission of the first principal. If the first principal has write access to certain subroutines within the call stack and has initiated these certain subroutines, then the first principal may have debugging access permission to those certain subroutines within the call stack. For example, if the first principal has write access to file10, and is debugging a process started by a second principal, then whenever file10 is written to by the second principal's process (multiple write calls at different points during the life time of the debugged process), then the write calls are presented in the restricted call stack. Thus, the restricted view of the call stack includes one or more subroutines written by the first principal to the call stack.

In operation 420, the daemon can grant debugging access permission to the complete code path. The complete code path is a code path that results in complete tracing for a system process. The term “code path” may refer to the path taken by the process while it executes. For example, the following pseudocode may illustrate a code path:

```
If(date == 15)
    Print “hi”
  Else
    Print “bye”
```

In the above psuedocode, there are 2 code/execution paths. One that prints “hi” when the date is 15 and the other that prints “bye” for every other date that is not 15. Similarly, the debugging process can do something like:

```
If (process_being_traced was started by the same principal starting
debugging process)
Then
  Complete code path of debugging process
Else
  Restricted code path of debugging process.
```

Note that by virtue of the “Complete code path of debugging process” the complete call stack of the process being traced can be obtained. Similarly, by virtue of the “restricted code path of debugging process” the restricted call stack of the process being traced is obtained.

The complete code path is executed when the first principal has requested to trace a system process started by the first principal. In various embodiments, even if first principal has write access, the first principal is not immediately granted access to the complete code path due to security reasons mentioned herein.

In operation 422, the daemon can enable the debugging process based on the debugging access permission of the first principal. The daemon can provide one or more debugging details on the object to the first principal through a debugging program. The debugging process may differ depending on the type of debugging process initiated. For example, operation 422 can be explained with reference to tracing.

In operation 424, the daemon can determine whether the debugging process has stopped. For example, the daemon can monitor the debugging program for an end status to make the determination. In various embodiments, a user can abort the debugging process which could also trigger a stop.

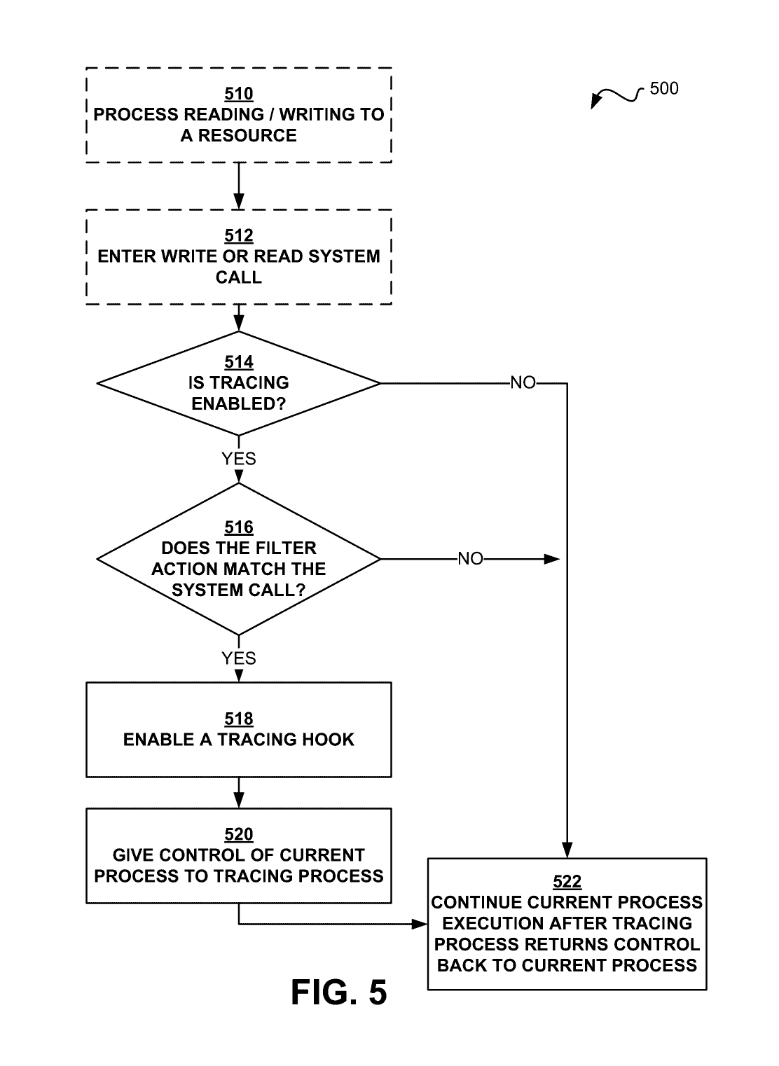

FIG. 5 illustrates a flowchart of a method 500 of enabling a debugging process for a principal, according to various embodiments. Aspects of method 500 may correspond to operation 422 in FIG. 4. Various operations in method 500 may not be temporally tied to the method 400 in FIG.4. For example, the operation 510 and operation 512 may not tied specifically to operation 422 in FIG. 4. Although a tracing example is provided, nothing within the disclosure is limited to only tracing with respect to the debugging process. For example, other debugging processes may be used such as auditing or accounting.

In operation 510, a principal starts a system process to read/write/another system process to an object (e.g., file) via the operating system. Thus, the system process is in existence prior to enabling tracing on the system process.

In operation 512, a read/write system call may be entered by a computer program that is modifying the object. For example, if a file is being written to by a program, a system call may be used by the computer program to request a service from the operating system's kernel.

In operation 514, the daemon can determine whether the system call has tracing enabled. For example, the daemon can access a place in the kernel to know if the tracing process has requested to trace read or write actions on the object. If tracing is enabled for the system process, then the method 500 can continue to operation 516. In operation 516, the daemon can filter the debugging process to be traced. For example, inside the function (write( )/read( ) system call) (which is responsible for the action “write”/“read”) the daemon can check if the filter criteria is matched. Assuming that the read system call is accessed, but the trace wants data only for the writes done to the object, then filter action does not match the system call and the hook is not be enabled in the read system call.

A condition may be specified for the filter (F1). For example, The filter Fl may resemble: match the target resource (File1) for which the tracing is invoked and the resource for which the write( )system call is invoked (e.g., does “File_descriptor” match “File A” resource?). Assuming that Filter Fl has criteria or checks, a first check checks the File_descriptor. As write and read system calls are invoked by multiple processes on multiple files on the system, the invoked writes or reads need to enable/execute the hook which are meant for writing to or reading from the file (e.g., File1).

A second check is illustrated by the following pseudocode:

```
int write(File_descriptor , .. , ... )
  {
    If (F1)
      enable_hook( );  //
    ...
    ...
  }
```

Where F1 can be the following pseudocode:

If (the target resource (File 1) for which the tracing is invoked = = the
resource for which the write( ) system call is invoked) i.e if (“File_
descriptor” = = “File1”)

Thus, a filter action for a particular action needs to match the system call in order to trigger a trace.

In operation 518, the daemon can enable a tracing hook on the object. The tracing hook in the “write( )”/“read( )” sys call can be activated and the current system process control is transferred to a debugging process in operation 520. Various entities may use a hook mechanism within a dynamic tracing tool (e.g., Probevue command). The hook mechanism may be embedded in the read/write system call( ).

The system call may first invoke a filter to check if tracing is to be enabled for this file being read or written to or not (e.g., operation 514). If this filter check is passed, then a hook-like mechanism is enabled in operation 518. The tracing hook transfers control from the process reading/writing to the file to the debugging process (assuming that the debugging program is running). Once the debugging process is entered via the tracing hook in read/write system call, the debugging program takes the readings of the process being traced(i.e., the system process that invoked read/write system call).

Once the debugging program has taken the trace/debug statistics (e.g., what is the value of a variable, what is the CPU the process accessing this file is running on etc.), control is transferred back to the system call (the system process that was being traced) in operation 520. The execution of the system call starts from where it left.

For example, in an exemplary process X that needs to be traced by the debugging process, the debugging process cannot report a trace or cannot debug process X unless the debugging process has access to process X's data. Thus, the tracing hook mechanism to transfer control from process X to the debugging program so that the debugging program can quickly see the things it wants to see and return the control back to process X. Process X will proceed as before, but with a slight delay that the debugging program caused by investigating. There may be other approaches to invoke a debugging program from process X. A tracing hook is simply one such example.

Writes to objects can invoke the above system call. When P1 has invoked the tracing action, the writes that happen to “File A” are traced. A Filter, (e.g., F1) may serve the purpose of filtering which actions need to be traced for the principal. If a write is happening on a different file to which P1 has no access to (e.g., “File B”), then a tracing hook is not enabled. As the hook in the “write( ) sys call is activated, all the writes to the resource File A will be traced and a report will be generated for the same.

In operation 522, the daemon can transfer control back to the system process that was being traced.

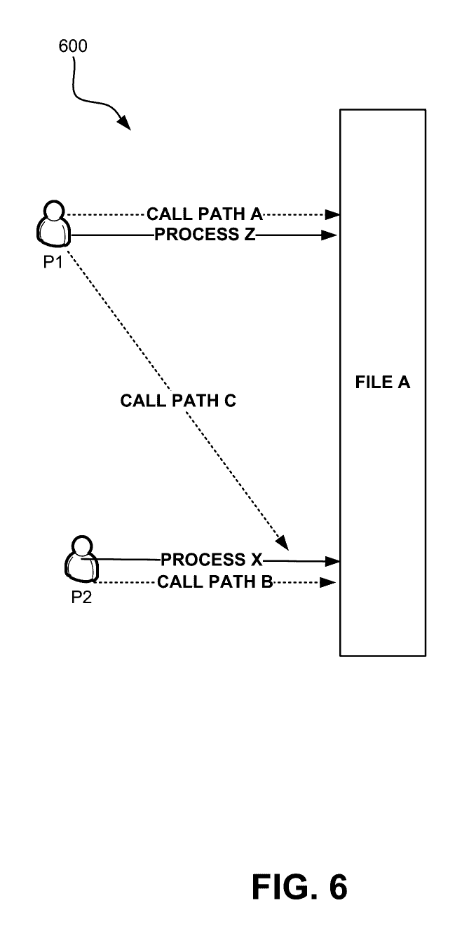

FIG. 6 illustrates a block diagram of a system 600 that controls the tracing process of principals, according to various embodiments. For example, Processs X is started by P2 and Process Z is started by P1. Thus, P1 has full tracing on his own process Process Z, and P1 gets a call path/call stack “A”. Similarly, P2 has full tracing on process X and has access to call path/call stack “B”. When P1 is tracing process X, P1 is given a restricted version of the debugging process via call stack/call path “C” which is smaller and restricted in comparison to call path/call stack “B”.

In the cases with any kind of access (write, read, or both) to the object “File A”, restricted version of tracing is enabled when the principal who invokes a debugging process on another system process which the principal did not start/initiate. A complete version of tracing is enabled when the principal who invokes the debugging process on another system process which the principal started.

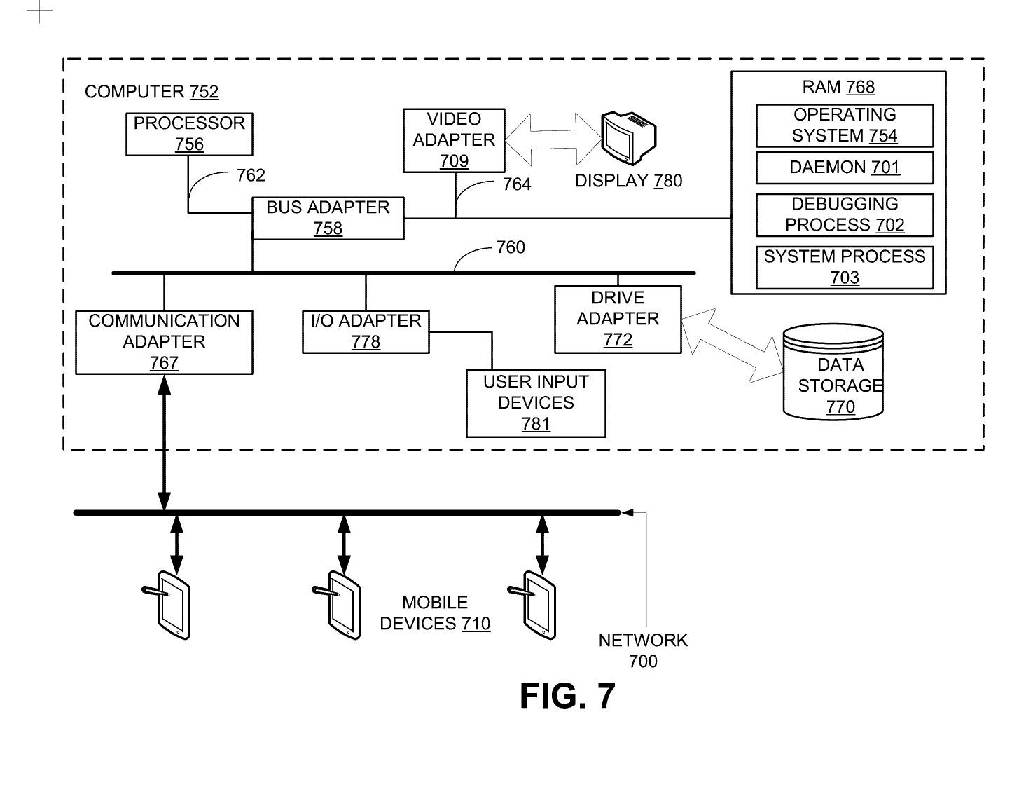

FIG. 7 depicts a block diagram of automated computing machinery, according to an embodiment. The computing machinery can include example computer 752 useful in performing aspects of the disclosure, according to various embodiments. The computer 752 of FIG. 7 includes at least one computer processor 756 or ‘CPU’ as well as random access memory 768 ('RAM') which is connected through bus adapter 758 to processor 756 and to other components of the computer 752.

Also stored in RAM 768 is an operating system 754. Operating systems useful for record filtering according to embodiments of the present invention include UNIX®, Linux®, Microsoft XP™, AIX®, IBM's i5/OS™, and others. The operating system 754 and daemon 701 are shown in RAM (768), but many components of such software typically are stored in non-volatile memory also, such as, for example, on a data storage 770. The RAM 768 may also contain a debugging process 702 and a system process 703.

The computer 752 can also include disk drive adapter 772 coupled through expansion bus 760 and bus adapter 758 to processor 756 and other components of the computer 752. Disk drive adapter 772 connects non-volatile data storage to the computer 752 in the form of disk drive 770. Disk drive adapters useful in computers include Integrated Drive Electronics (IDE') adapters, Small Computer System Interface (‘SCSI’) adapters, and others. Non-volatile computer memory also may be implemented for as an optical disk drive, electrically erasable programmable read-only memory (so-called ‘EEPROM’ or ‘Flash’ memory), RAM drives, and so on.

The example computer 752 includes one or more input/output (I/O′) adapters 778. I/O adapters implement user-oriented input/output through, for example, software drivers and computer hardware for controlling output to display devices such as computer display screens, as well as user input from user input devices 781 such as keyboards and mice. The example computer 752 includes a video adapter 709, which is an example of an I/O adapter specially designed for graphic output to a display device 780 such as a display screen or computer monitor. Video adapter 709 is connected to processor 756 through a high speed video bus 764, bus adapter 758, and the front side bus 762, which is also a high speed bus.

The example computer 752 includes a communications adapter 767 for data communications with other computers 710, e.g., mobile devices, and for data communications with a data communications network 700. Such data communications may be carried out serially through RS-232 connections, through external buses such as a Universal Serial Bus ('USB'), through data communications networks such as IP data communications networks, and in other ways as will occur to those of skill in the art. Communications adapters implement the hardware level of data communications through which one computer sends data communications to another computer, directly or through a data communications network. Examples of communications adapters include modems for wired dial-up communications, Ethernet (IEEE 802.3) adapters for wired data communications network communications, and IEEE 802.77 adapters for wireless data communications network communications.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method for managing a debugging process, comprising:
receiving a request for the debugging process from a first principal, the debugging process accesses a system process for an object of a computer program operating on a computer, the computer having a call stack that stores information about one or more active subroutines of the object;
determining that the first principal has at least an access permission to the object;
granting, based on the access permission of the first principal, a debugging access permission to the first principal for a restricted code path of the call stack, the restricted code path allows a restricted view of the call stack to the first principal; and
providing one or more debugging details on the object to the first principal.

2. The method of claim 1, wherein the restricted view of the call stack is less than an administrator view of the call stack.

3. The method of claim 2, further comprising:
determining whether the first principal has a write access permission;
wherein the granting the debugging access permission for the restricted code path of the call stack occurs based on the write access permission of the first principal and based on an initiator status of the first principal; and
wherein the restricted view of the call stack includes one or more subroutines written by the first principal to the call stack.

4. The method of claim 1, further comprising:
determining that the system process is initiated by a second principal;
wherein the granting the debugging access permission for the restricted code path of the call stack occurs based on the access permission and based on an initiator status of the second principal.

5. The method of claim 1, wherein the first principal is a non-root, non-privileged user; and
further comprising:
determining that the system process is initiated by the first principal; and
granting the debugging access permission for a complete code path of the call sack based on the system process being initiated by the first principal.

6. The method of claim 1, wherein the computer implemented method is performed by an operating system daemon operating on computing machinery.

7. The method of claim 1, further comprising:
determining that tracing is enabled; and
wherein the granting the debugging access permission includes:
filtering the debugging process to be traced;
enabling a tracing hook on the object; and
granting tracing access permission responsive to the tracing being enabled.

8. A system for managing a debugging process, comprising:
a processor;
a memory communicatively coupled to the processor, the memory manages a call stack that stores information about one or more active subroutines of the object;
an operating system, communicatively coupled to the processor and the memory, the operating system is configured to create a system process for an object of a computer program and causes the processor to process one or more active subroutines of the object;
an operating system daemon, communicatively coupled to the processor and the memory, configured to:
receive a request for the debugging process from a first principal, the debugging process accesses a system process for the object of the computer program;
determine that the first principal has at least an access permission to the object;
grant, based on the access permission of the first principal, a debugging access permission to the first principal for a restricted code path of the call stack, the restricted code path allows a restricted view of the call stack to the first principal; and
provide one or more debugging details on the object to the first principal.

9. The system of claim 8, wherein the restricted view of the call stack is less than an administrator view of the call stack.

10. The system of claim 9, wherein the operating system daemon is configured to:
determine whether the first principal has a write access permission;
wherein granting the debugging access permission for the restricted code path of the call stack occurs based on the write access permission of the first principal and based on an initiator status of the first principal; and
wherein the restricted view of the call stack includes one or more subroutines written by the first principal to the call stack.

11. The system of claim 8, wherein the operating system daemon is configured to:
determine that the system process is initiated by a second principal;
wherein granting the debugging access permission for the restricted code path of the call stack occurs based on the access permission and based on an initiator status of the second principal.

12. The system of claim 8, wherein the first principal is a non-root, non-privileged user.

13. The system of claim 8, wherein the operating system daemon is configured to:
determine that the system process is initiated by the first principal; and
grant the debugging access permission for a complete code path of the call stack based on the system process being initiated by the first principal.

14. The system of claim 8, wherein the operating system daemon is configured to:
determine that tracing is enabled; and
wherein granting the debugging access permission includes:
filtering the debugging process to be traced;
enabling a tracing hook on the object; and
granting tracing access permission responsive to the tracing being enabled.

15. A computer program product for managing a debugging process comprising a computer readable storage device having a computer readable program stored therein, wherein the computer readable program, when executed on a computing device, causes the computing device to:
receive a request for the debugging process from a first principal, the debugging process accesses a system process for an object of a computer program operating on a computer, the computer having a call stack that stores information about one or more active subroutines of the object;
determine that the first principal has at least an access permission to the object;
grant, based on the access permission of the first principal, a debugging access permission to the first principal for a restricted code path of the call stack, the restricted code path allows a restricted view of the call stack to the first principal; and
provide one or more debugging details on the object to the first principal.

16. The computer program product of claim 15, wherein the restricted view of the call stack is less than an administrator view of the call stack.

17. The computer program product of claim 16, wherein the computer readable program causes the computing device to:
determine whether the first principal has a write access permission;
wherein granting the debugging access permission for the restricted code path of the call stack occurs based on the write access permission of the first principal and based on an initiator status of the first principal; and
wherein the restricted view of the call stack includes one or more subroutines written by the first principal to the call stack.

18. The computer program product of claim 15, wherein the computer readable program causes the computing device to:
determine that the system process is initiated by a second principal;
wherein granting the debugging access permission for the restricted code path of the call stack occurs based on the access permission and based on an initiator status of the second principal.

19. The computer program product of claim 15, wherein the first principal is a non-root, non-privileged user.

20. The computer program product of claim 15, wherein the computer readable program causes the computing device to:
determine that the system process is initiated by the first principal; and
grant the debugging access permission for a complete code path of the call stack based on the system process being initiated by the first principal.
